(19) United States
(12) Patent Application Publication
(10) Pub. No.: US 2007/0194917 A1
(43) Pub. Date: Aug. 23, 2007

(54) Method And Device For Detecting A Passage Associated With An Access Door

(76) Inventors: Pierre Girod, Aurons (FR); Nicolas Pequeux, Ganshoren (BE); Samuel Jadin, Evere (BE)

Correspondence Address: YOUNG & THOMPSON, 745 SOUTH 23RD STREET, 2ND FLOOR, ARLINGTON, VA, 22202, US

(21) Appl. No.: 10/592,933

(22) PCT Filed: Jul. 8, 2004
(86) PCT No.: PCT/FR04/01786

§ 371 Date: Jan. 26, 2007

(30) Foreign Application Priority Data
Mar. 17, 2004 (FR) 04/02729

(51) Int. Cl. G08B 13/18; G08B 23/00

(52) U.S. Cl. 340/556; 340/573.4

(57) ABSTRACT

A method for detecting a passage associated with an access door, for example a boarding door or a building entrance, which is secured in order to ensure passage of a single person includes producing the profile of an entering person by a first level detection device formed by the vertical bars of active infrared cells (D1), and opening or holding closed the access door according to the profile.

This invention relates to a method for detecting a passage associated with an access door, for example an immigration control point, a boarding gate or the entrance to a secure building in particular in order to guarantee the passage of one person only.

The invention also relates to a device for detecting a passage which is able to implement the method according to the invention.

In the access doors above it is necessary to guarantee the passage of one person only in order to prevent any risk of fraudulent passage of an unauthorized person which could have serious consequences in particular for security.

In particular according to WO 93/05487 a security door is known comprising sensors capable of detecting the simultaneous presence of two people in the passage compartment of the door.

However, the detection system described in this document is not totally reliable.

In fact, a reliable detection system must be able to more than 99% guarantee the passage of one person only.

For this purpose, this system must be able to detect, the passage:
of two people side by side or following one another very closely,
of a single person accompanied by a child,
of a single person pulling or pushing a trolley or other luggage (coat, small suitcase, etc.)
of a single person carrying a child, a bag.
a single person hesitating or hopping, etc.

The purpose of the present invention is to improve the known methods for detecting a passage in order to almost completely guarantee the passage of one person only.

According to the invention, the method for detecting a passage associated with an access door, for example an immigration control point, a boarding gate or the entrance to a secure building in particular in order to guarantee the passage of one person only is characterized in that the profile of the person is determined by means of a vertical row of infra-red emitting cells D1 arranged at the entry to the door opposite receiving cells connected to a control unit CU which manages the sampling and the frequency of emission of the signals and as a function of this profile, the access door is opened or remains closed.

The profile obtained according to the invention not only facilitates comparison between the profiles obtained, but makes it possible to distinguish clearly between a single person, two people directly behind one another, a single person carrying or pulling an item of luggage, etc.

Preferably, certain zones of the profile are filtered in order to mask out or eliminate interference zones.

Preferably also, the profile is divided into zones that are processed separately.

Moreover, each zone is characterized as a function of its dimension in order to determine whether the zone corresponds to a man, a child or an object.

According to an advantageous version of the invention, each zone which touches the ground is characterized so as to distinguish, by the shape of the zone, a child from a trolley and a child from a satchel or a backpack and each zone which does not touch the ground is characterized so as to distinguish a carried child, from an item of luggage.

Preferably, an additional filtering is carried out in order to eliminate backward movements of the person and the profiles are reduced to their true size.

The profiles obtained according to the method of the invention make it possible to detect, in particular:
a person accompanied by a child,
two people following one another very closely,
a person moving forwards then backwards and moving forwards again,
a person jumping,
a child following a large trolley,
a person carrying a backpack,
a person carrying a child on their back.

According to other characteristics of the method:
after dividing the profile into zones, the size and the volume of each zone is determined,
after identification of a zone touching the ground, a trolley or a bag is identified as a function of the volume of the zone,
after identification of a zone not touching the ground, a child or a bag is identified as a function of the volume of the zone,
after filtering and before dividing into zones, the passage of several people side by side is detected.

According to another feature of the invention, the device for detecting a passage associated with an access door, for example, a boarding gate or entry to a secure building in particular in order to guarantee the passage of one person only, is characterized in that it comprises:
a first detection level formed by a vertical row of active infrared emitting cells (D1) arranged opposite a vertical row of receiving cells in order to determine the profile of a person who is entering, these cells being connected to a central processing unit (CPU) which manages the sampling and the frequency of emission of the signals and means for controlling the opening of the access door or keeping it closed.

According to a particular embodiment of the invention, the device comprises:
a speed sensor D3, for determining the speed of passage of the person,
means for modifying the profile determined by the first detection level in order to obtain a profile independent of the speed of passage,
means for comparing the profile obtained with an architecture of profiles contained in a memory.

According to other features of this device:
the means for determining the speed of passage comprise a Doppler radar,
it comprises a second detection level formed by a passive infrared cell or thermopile, for detecting the presence of a cold body,
the second detection level precedes the third detection level which is constituted by the speed sensor,
the radar of the third detection level is arranged at a certain distance from the entry to the access door and is orientated so as to send its beam towards this entry,
passive infrared cells or thermopile of the second detection level comprise at least one cell arranged at the entry to the door and orientated so as to send their beam transversely to the passage,
it comprises a 5^{th} detection level for detecting the simultaneous passage of two people, comprising ultrasonic detectors arranged transversely to the passage,
the sensors of the fourth detection level comprise at least two ultrasonic detectors arranged in the upper part of the entry to the access door and orientated so as to diffuse their beam downwards.

Alternatively the fourth detection level can be carried out by:
a) a detection of feet by means of distance sensors, situated horizontally at the bottom of the equipment
b) analysis of a camera image taken from the front (detection of contours)

Other features and advantages of the invention will also become apparent in the course of the following description.

In the attached drawings, given by way of non-limitative examples:

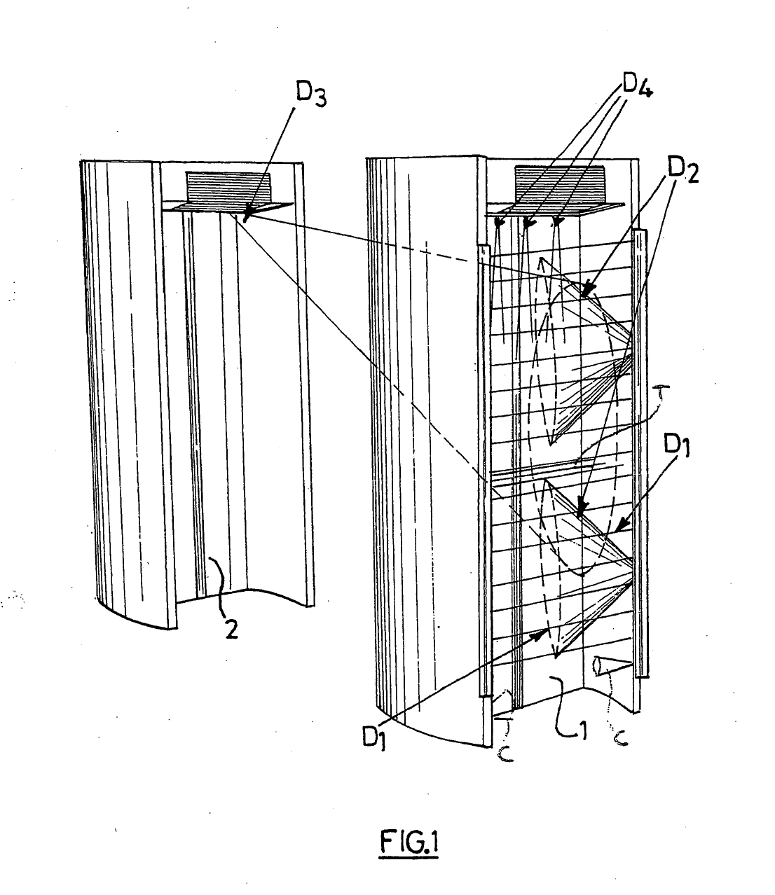

FIG. 1 is an overall perspective view of a device for detecting a passage according to the invention,

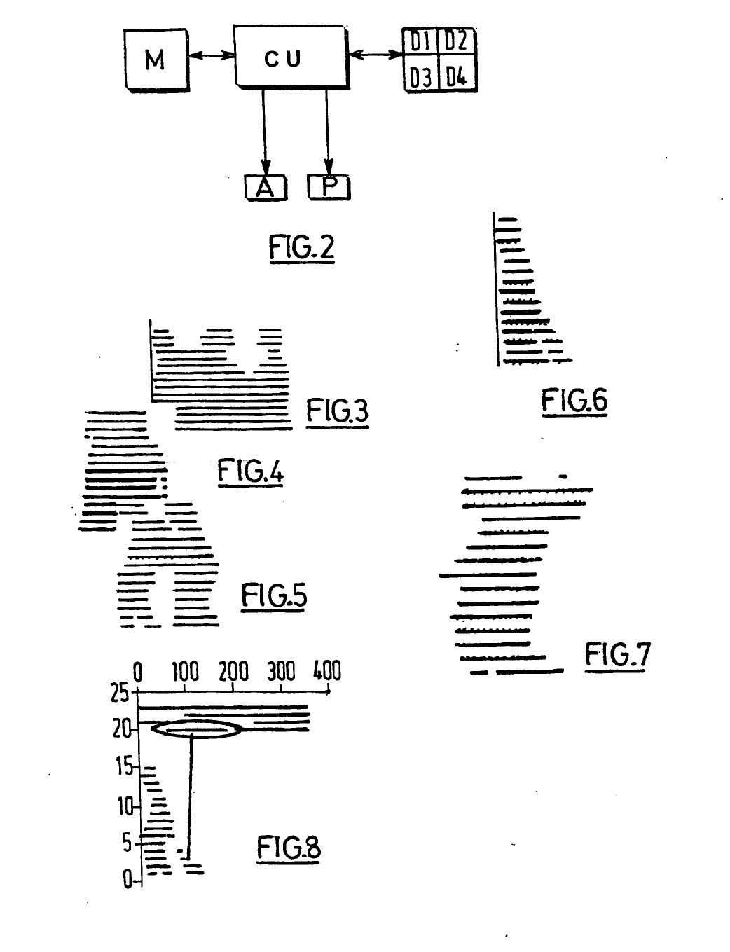

FIG. 2 is a diagram of the control system associated with the device,

FIGS. 3 to 7 show different examples of profiles obtained by the first detection level,

FIG. 8 shows a profile obtained by combining the first and the second detection levels,

FIG. 9 shows a profile obtained by combining three detection levels,

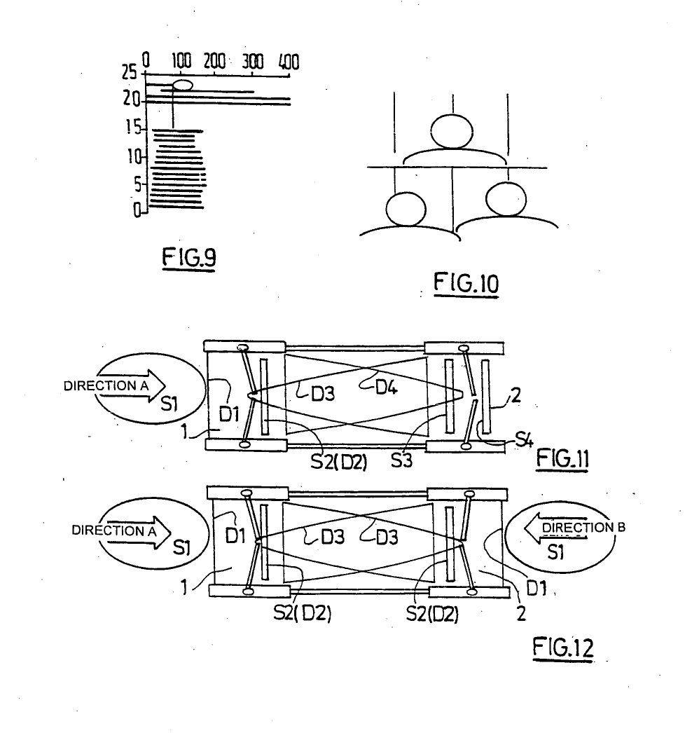

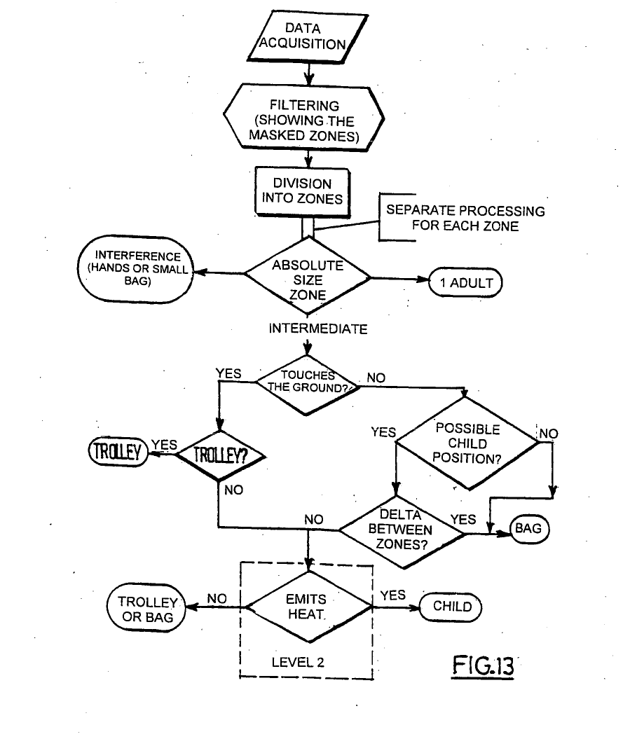

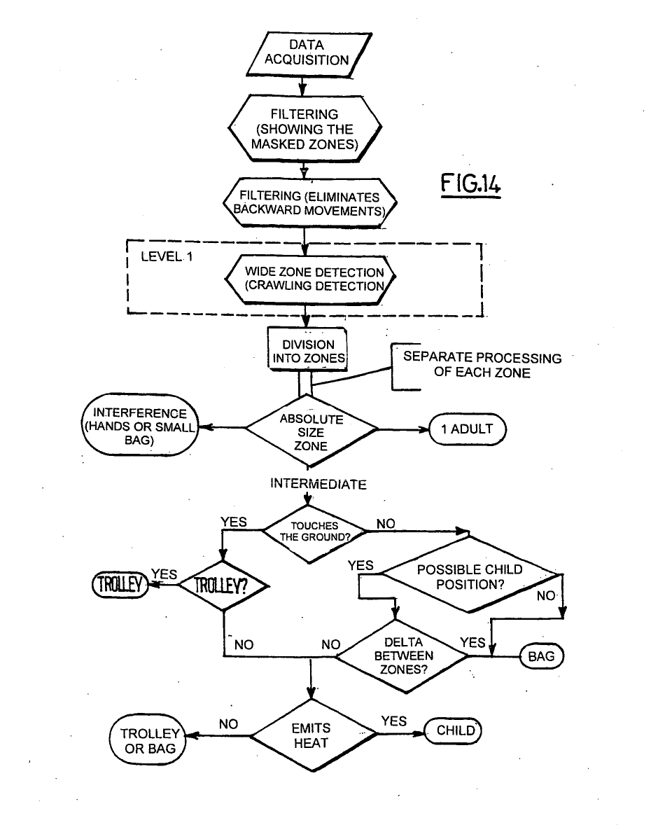

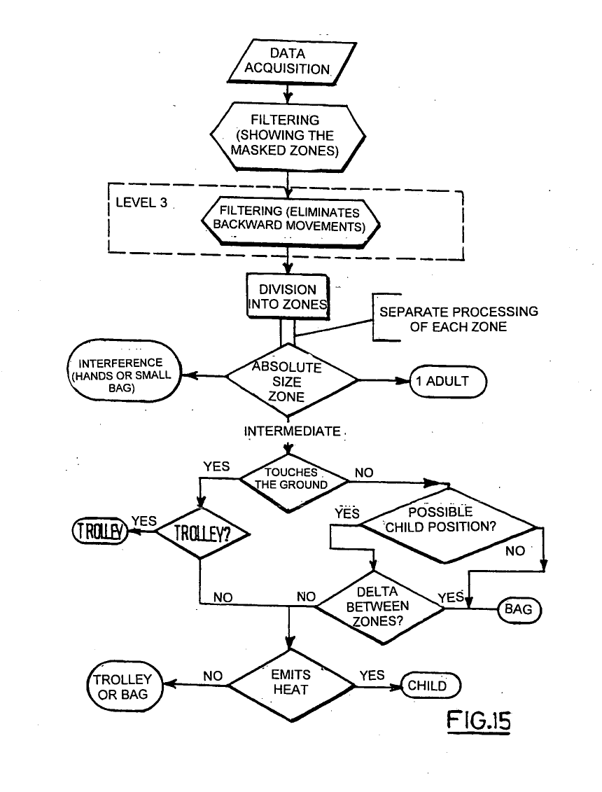

FIG. 10 illustrates the frontal detection of one person and of two people,

FIG. 11 is a diagrammatic plan view of a monodirectional device with two doors,

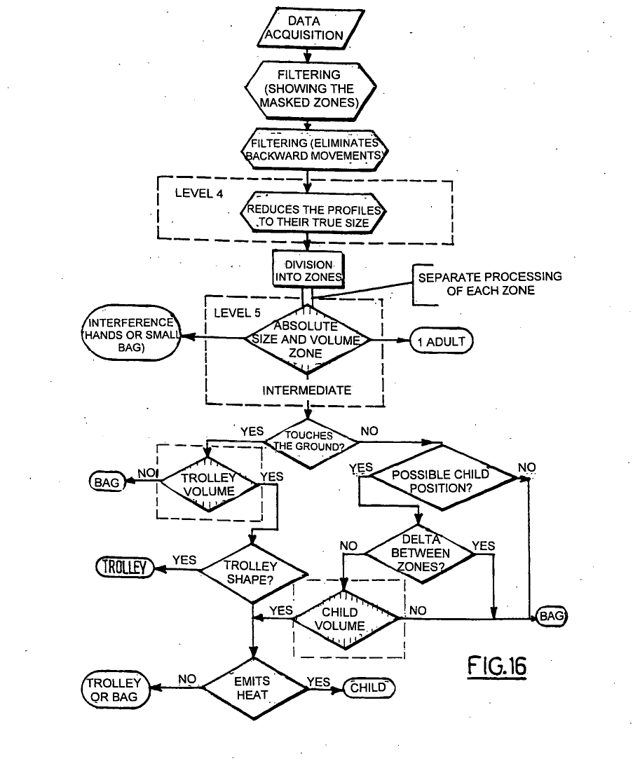

FIG. 12 is a diagrammatic plan view of a bidirectional device with two doors,

FIGS. 13 to 17 are diagrams showing the sequence of the programs during the successive implementation of the different detection levels,

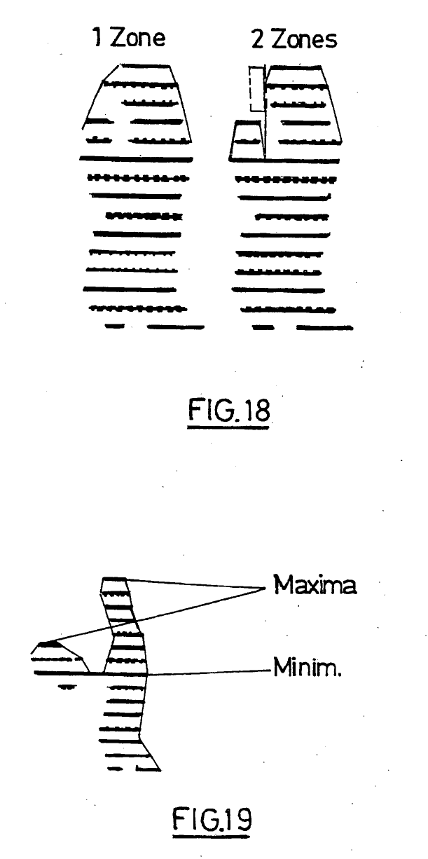

FIG. 18 illustrates the stage of dividing the profile obtained into zones,

FIG. 19 illustrates the stage of detection of the maxima and minima of the profile obtained,

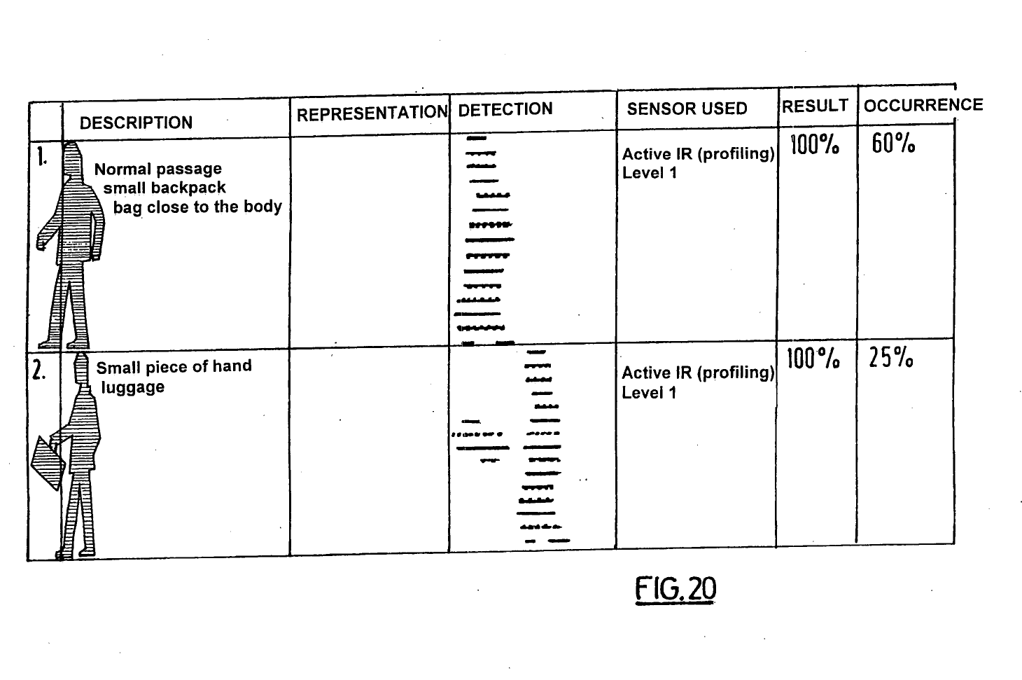

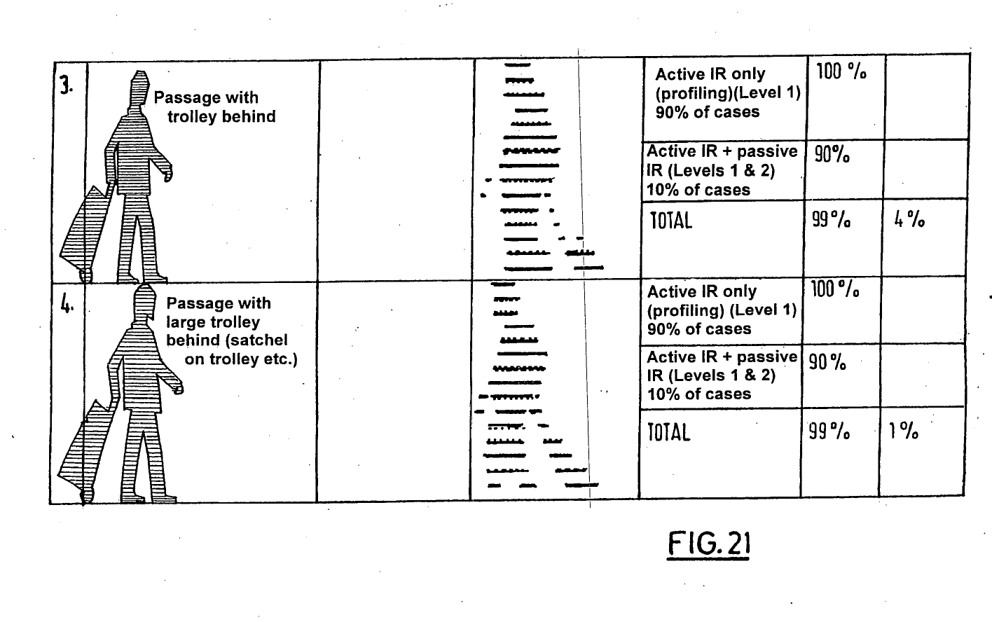

FIGS. 20 and 21 illustrate four examples of detection.

In the embodiment represented in FIG. 1, the device comprises an access door comprising an entry 1 and an exit 2 giving access to a departure area or to the entrance of a building.

This access door comprises a certain number of sensors D1, D2, D3, D4 the positions and the functions of which will be explained in detail below.

The device also comprises (see FIG. 2) a central processing unit CPU which communicates with a memory M which contains an architecture of profiles and with the different sensors D1, D2, D3, D4. The central processing unit CPU is also able to open the door P or keep it closed and trigger an alarm A.

The access door comprises several levels of detection.

The first detection level is realized by recognition of the profile of the person and the objects.

In order to acquire the profile of the people/objects passing through the door, two rows of active infrared emitting/receiving cells (D1) are used placed vertical to the entry 1 to the door in order to create a vertical curtain of transverse beams.

This profile recognition system allows detection only of the great majority of “normal” passages through the door.

In particular, it makes it possible to detect:
any tailgating or piggybacking (people following one another closely or carrying luggage),
adults accompanied by children.

The following cases are difficult to identify with the 1^{st} detection level (i.e. they can be detected but with less reliability of detection):

1. distinguishing between:
a. a person partially passing through the door then moving back a step then passing through the door (see the profile represented in FIG. 3),
b. a person making a half-turn (see the profile in FIG. 4),
c. tailgating (see the profile in FIG. 5), i.e. two people following one another closely,

2. a person jumping/stepping over the detection cells,

3. distinguishing between a large trolley and a child who is tailgating,

4. distinguishing between a backpack and a child on someone's back (see the profile in FIG. 6),

5. the passage of several people side by side.

In order to distinguish between a human and non-human in cases “3” and “4” identified with level 1 above, passive infrareds sensors are used in order to constitute a second detection level. The passive infrared sensors used (D2) are so-called “intelligent” sensors, i.e. capable of adapting to their environment thus overcoming the main fault of conventional active infrared sensors (that is, the strong influence of the environment). These sensors can also be thermopile sensors or sensors with ambient temperature compensation.

The profiling realized with level 1 indicates in cases “3” and “4”, whether it is:
a suitcase or a bag
probably a suitcase or a bag
probably a child
a child.

The detection by passive infrared cell makes it possible in the detection of level 2 to make a decision on the 2^{nd} and 3^{rd} points above.

FIG. 7 shows at the bottom of the figure the profile obtained by the sensors D1 and at the top the profile obtained by the sensor D2.

In order to improve the detection two passive infrared sensors D2 are used, as shown in FIG. 1.

It is also possible to improve the reliability using four sensors D2 by arranging two sensors opposite two other sensors.

If it is desired to distinguish between a person partially passing through the door then moving back a step then passing through the door, a person making a half-turn, and two people following one another closely, it is necessary to acquire an idea of the direction of movement. This information is provided:
by a Doppler radar D3 facing the entry to the door, as shown in FIG. 1, or
by two or three successive active infrared barriers being passed through.
by a distance measurement taken facing the passage (measurement at regular intervals).

Thus a third detection level is realized. FIG. 8 shows the result of this detection.

Knowing the speed of passage of a person and optionally of an object, it is possible to modify the profiles in order to distinguish them with regard to speed in order to facilitate their comparison with the architecture of profiles stored in the memory M. This fourth level of recognition of the detected profiles makes it possible to considerably improve the performance of the system.

A fifth detection level is envisaged in order to detect people passing through the entry 1 of the door side by side.

This detection is particularly useful in the case of wide passages. In fact, profile detection (level 1) does not allow detection of people simultaneously passing in front of the sensors. If the passage is not perfectly simultaneous it is probable that this fraud will also be detected by the profiling of level 1.

This detection can be carried out by:
a horizontal profiling carried out by ultrasonic detection cells D4 placed in the upper part of the entry 1 of the door. In the example represented in FIG. 1, the three sensors D4 send their beam downwards. These ultrasonic sensors can be replaced by laser or infrared sensors. Thus two profile detections can be used.
   These sensors provide the distance information in a continuous manner which allows a lateral profiling to be realized.
   The profiling, carried out by the three sensors D4, makes it possible to produce a three-dimensional grid of the person/object passing through the entry to the door. FIG. 10 shows at the top a normal passage of a person and at the bottom two people fraudulently passing through the entry side by side.
   A variant involves using, instead of ultrasonic sensors, a laser measurement system which, by means of a rotating mirror, can carry out the profiling in a vertical plane perpendicular to the plane of the profile.
   A variant involves using shape recognition on an image produced facing the passage.
Another technique involves using distance sensors c (see FIG. 1) in order to detect feet. When an adult or a child passes through, the feet are located and if the distance between them and the lateral uprights of the device is too small, then this means that:
   1. a person is passing through with very large strides (unlikely)
   2. a person is passing through with a trolley beside them (unlikely as trolleys are behind)
   3. two people are passing through side by side.
In order to distinguish between cases 2 and 3 above, the information provided by temperature sensors can be used. In fact, the heat given off at ground level by the leg is greater than that given off by the trolley. Moreover, the distance sensors are placed sufficiently low down so that passengers' suitcases are not detected.
Another solution involves using two detection levels 1 in which the sensors are crossed thus forming an X, which makes it impossible for two people to simultaneously pass through side by side for the two detection levels 1.
Another solution involves using a capacitive measurement system (DMI). When a person passes through the door, the capacitance measurement between the conductors (placed on either side of the passage) changes because the human body has dielectric characteristics markedly different from air. This technique can be used in order to detect two people passing through side by side because the difference in capacitive measurement of two people rather than just one can be measured.
It is also possible to improve the detection of this level (detection level 5) as well as that of level 1 by the use of several separate capacitive measurement sections. These sections are arranged vertically (for example, a first section 10 mm to 310 mm high, another 600 to 900, 1200 to 1500).

In a door with unidirectional access no detection of passage of one person only is carried out at the exit. In order to ensure that nobody enters the control point from the opposite side, two radars are installed at the top of the entry 1 and of the exit 2 in order to ensure that after the exit door shuts again nobody remains in the control point.

One of the radars is equipped with x-MTF technology making it possible to detect a mere presence (the radar is then capable of detecting very slight movement such as the movement of the ribcage caused by breathing).

An alternative to this solution involves using a system for the supervision of an active infrared control point or an multispot active IR sensor in order to monitor a presence or lack of presence in the airlock. This solution has the advantage of detecting suitcases left inside the control point.

FIG. 1 further shows, by horizontal lines T, the locations of the speed and direction detection cells.

FIGS. 11 and 12 show in plan view the access door and the locations of the various sensors.

FIG. 11 illustrates the case of a unidirectional door which is passed through in direction A.

FIG. 12 illustrates the case of a bidirectional door which can be passed through in two directions A and B. In these figures S1, S2, S3, S4 designate sensors which are not the subject of the present invention but which are necessary for the operation of the device.

The sensors D1, D2, D3, D4 have already been defined above and provide the different detection levels of the invention.

Thus, in the case of a unidirectional device such as represented in FIG. 11:
S1 is a Doppler effect radar arranged at the entry to the first door in direction A,
S2 is an active infrared cell arranged at the exit from the first door in direction A,
S3 is an active infrared cell arranged at the entry to the second door in direction A,
S4 is an active infrared cell arranged at the exit from the second door in direction A,
D1 is a curtain of active IR cells associated with passive IR cells in order to determine the profiles and make the distinction between a person and an object,

D1 combined with D2 (which can be S2) or with D3 (Doppler radar) intended to determine the direction of passage and the speed,
D3 and D4 are Doppler radars for detecting the presence of a person between the two doors and intrusion from the opposite direction,
D5 is a curtain of active IR cells which is used in the case of wide doors only.
   In the case of the bidirectional device according to FIG. 12, the arrangement of the sensors S1, S2 (D2), D1, D5 is symmetrical for the two doors.

The table below shows the different detections carried out by the device according to the invention:

| | Detection | | | | | | |
|---|---|---|---|---|---|---|---|
| | PASSAGE OF ONE PERSON ONLY | | | | | | |
| | LEVELS | | | | | Detection of | PHYSICAL |
| OBSTACLES | 1 | 2 | 3 | 4 | 5 | PRESENCE | obstacle |
| Sensors | D1 | D1 | D1 + D2 | D1 + D2 or | D5 | D3 + D4 | |
| | | | or D3 | D3 | | | |
| Procedures | Rough | Human/ | Direction of | Speed of | Frontal | Intrusion | |
| | profile | Non-human | movement | movement | passage | in opposite | |
| | | | | | | direction | |
| Tailgating/ * | X | x | (x) | (x) | | | |
| Piggybacking | | | | | | | |
| Adult + | X | x | (x) | (x) | | | |
| Child on foot | | | | | | | |
| Trolleys | X | x | (x) | (x) | | | |
| Jump over ** | | | | | | | X |
| Slip through *** | X | | | | | | |
| Jumping at | X | | | x | | | |
| entry | | | | | | | |
| Child on back | X | X | | | | | |
| Child sitting | (x) | | | | | | X |
| on shoulders | | | | | | | |
| Child behind | (x) | | | | | | X |
| a skirt | | | | | | | |
| Frontal | X | (X) | | | X | | |
| tailgating **** | | | | | | | |

* two people following one another closely or a person carrying luggage
** jump over
*** slip through
**** two people side by side

The program which controls the different detection and recognition functions is written for example in Visual C++. Other programming languages such as programmed PLC or others can be used without exceeding the scope of the invention.

The program can be run on a PC connected to the central processing unit CPU.

The diagrams represented in FIGS. 13 to 17 describe the successive phases of the program implemented in the different detection levels.

Thus, the diagram in FIG. 13 shows the different program phases implemented in detection levels 1 and 2.

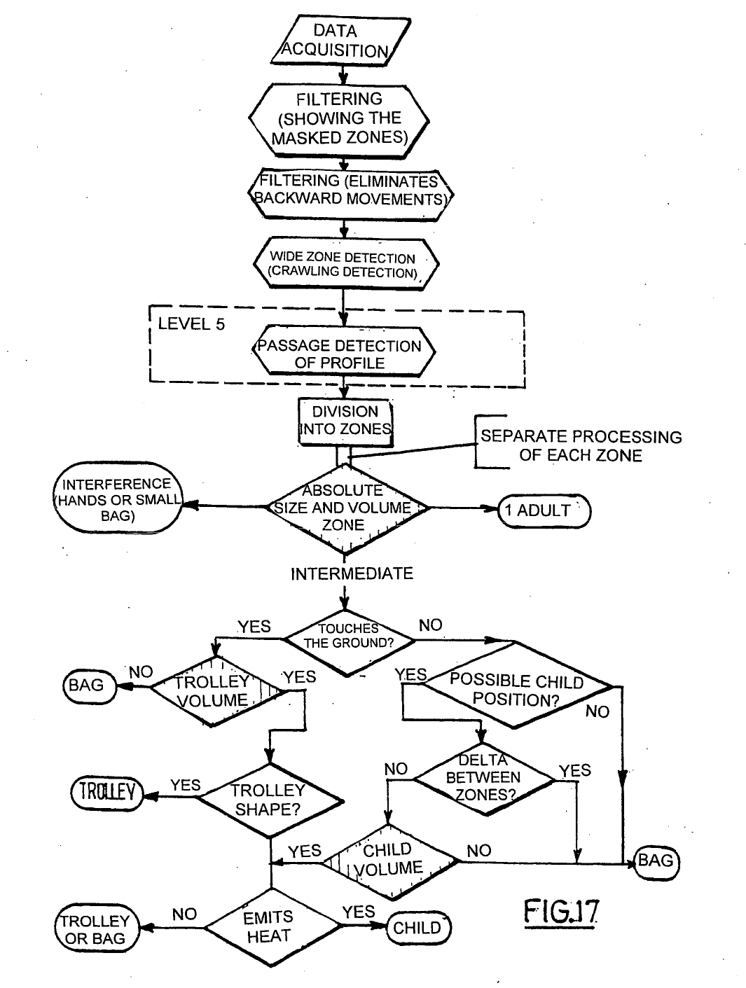

The diagram in FIG. 14 adds to the phases shown in FIG. 13 the detection of a wide zone realized using the IR detection cells placed at the exit from the first door.

The diagram in FIG. 15 adds to the phases shown in the diagram in FIG. 13, those implemented at detection level 3.

The diagram in FIG. 16 adds to the phases shown in the diagram in FIG. 13, those implemented at detection level 4.

The diagram in FIG. 17 adds to the phases shown in the diagram in FIG. 13, those implemented at detection level 5.

The different functions implemented in the different detection levels will now be described in more detail.

Level 1:

The active infrared sensors D1 form a curtain of infrared beams which is passed through by one or more persons and optionally an object.

The control unit CU establishes profiles by means of a control logic.

Filtering Phase:

In order to show certain zones which can be masked by unnecessary information, a first filtering is necessary.

It is also necessary to filter certain garbage, i.e. the zones which are too small corresponding to hands, straps, etc.

This filtering corresponds on the one hand to correction of the data and on the other hand to wiping of the garbage.

Phase of Dividing into Zones:

The profile is divided into zones which will be processed separately. In order to do this, the transitions (increase/decrease) are detected. This phase is illustrated by FIG. 18.

The maxima and the minima of the profiles (see FIG. 19) are also determined.

The maxima correspond to what may be people and the minima make it possible to isolate groups.

“Absolute Size Zone” Phase:

For each zone the maximum number of continuous cells is determined. This makes it possible to define the dimension of the object belonging to this zone.

This number is then compared to two parameters defining what is considered to be a suitcase or a bag and what is considered to be a person without the need for additional distinction.

In fact, an object of less than 50 cm for example cannot be a person, even a newborn. By contrast, an object more than 1 m 50 high for example is detected as a person (therefore if somebody enters the control point with a large double bass, it is probable that a fraud will be established. It should be noted that if the parameter is adjusted to 1 m 70 this situation will be resolved however the risk of non-detection is then slightly increased).

“Touching the Ground” Phase:

The aim of this function is to simply separate two cases which are to be processed separately because they have different characteristics.

In fact, this involves distinguishing
on the one hand a child from a trolley (touching the ground)
on the other hand a child from a satchel or a backpack (not touching the ground).

“Trolley Shape” Phase:

This part of the algorithm makes it possible to verify whether there is a child or a trolley, because a trolley is inclined and has a straight side, which a child does not have.

“Possible Child Position” Phase:

As a function of the height at which the object is situated it is possible to eliminate the possibility that it is a child.

For example, it is unlikely that a child is hanging onto its mother's legs; it is more likely to be a piece of luggage.

“Delta Between Zones” Phase:

This function makes it possible to determine the interval between two zones.

As the object does not touch the ground, it can only be a bag held at arm's length, or a satchel placed on a trolley, etc.

The other functions belong to the other detection levels the operating principle of which has been described previously.

FIGS. 20 and 21 illustrate several examples successively showing a person (Example 1 FIG. 20) passing normally through the access door, a person carrying an item of hand luggage (Example 2 FIG. 20), a person pulling a trolley and carrying a satchel (Examples 3 and 4—FIG. 21).

FIGS. 20 and 21 show for each example, the profile obtained, the detection levels, the result (success rate) and the rate of occurrence.

In the case of Examples 1 and 2, detection level 1 was sufficient to identify a single person and a person carrying a piece of luggage.

By contrast, in the case of Examples 3 and 4, detection levels 1 and 2 were used in order to obtain a 99% reliable result.

1. Method for detecting a passage associated with an access door, for example an immigration control point, a boarding gate or the entrance to a secure building in particular in order to guarantee the passage of one person only, characterized in that the profile of the person is determined by means of a vertical row of infra-red emitting cells (D1) arranged at the entry to the door opposite receiving cells connected to a control unit (CU) which manages the sampling and the frequency of emission of the signals and as a function of this profile, the access door is opened or remains closed.

2. Method according to claim 1, characterized in that certain zones of the profile are filtered in order to mask them or to eliminate interference zones.

3. Method according to claim 2, characterized in that the profile is divided into zones which are processed separately.

4. Method according to claim 2, characterized in that each zone is characterized as a function of its dimension in order to determine whether the zone corresponds to a person, a child or an object.

5. Method according to claim 2, characterized in that each zone which touches the ground is characterized in order to distinguish by the shape of the zone, a child from a trolley and a child from a satchel or a backpack.

6. Method according to claim 2, characterized in that each zone which does not touch the ground is characterized in order to distinguish a carried child from an item of luggage.

7. Method according to claim 2, characterized in that an additional filtering is carried out in order to eliminate backward movements of the person.

8. Method according to claim 1, characterized in that the profiles are reduced to their true size.

9. Method according to claim 3, characterized in that after dividing the profile into zones, the size and the volume of each zone is determined.

10. Method according to claim 3, characterized in that after identification of a zone touching the ground, a trolley or bag is identified as a function of the volume of the zone.

11. Method according to claim 3, characterized in that after identification of a zone not touching the ground, a child or a bag is identified as a function of the volume of the zone.

12. Method according to claim 2, characterized in that after filtering and before dividing into zones, the passage of several people side by side is detected.

13. Method according to claim 1, characterized in that from the profile obtained, in particular:
a person accompanied by a child,
two people following one another very closely,
a person moving forwards then backwards and moving forwards again,
a person jumping,
a child following a large trolley,
a person carrying a backpack,
a person carrying a child on their back are detected.

14. Method according to claim 1, characterized in that, by means of a speed sensor (D3), the speed of passage of the person is determined and the profile created by the first detection level is modified in order to obtain a profile independent of the speed of passage.

15. Method according to claim 14, characterized in that the speed of passage is determined by means of a Doppler radar (D3).

16. Method according to claim 14, characterized in that the speed of passage is determined by means of a distance sensor.

17. Method according to claim 14, characterized in that the speed of passage is determined by means of successively passing through at least two infrared barriers.

18. Method according to claim 1, characterized in that the presence of a cold body is detected by means of a second detection level formed by at least one passive infrared cell (D2).

19. Method according to claim 18, characterized in that the second detection level precedes a third detection level which is constituted by the movement direction sensor (D3).

20. Method according to claim 19, characterized in that the third detection level precedes a fourth detection level which is constituted by the speed sensor (D3).

21. Method according to claim 20, characterized in that, by means of a fifth detection level (D4) the simultaneous passage of two people is detected.

22. Method according to claim 21, characterized in that the detection is carried out by means of ultrasonic sensors (D4) arranged transversely to the passage.

23. Method according to claim 22, characterized in that the detection is carried out by means of a laser cooperating with a rotating mirror in order to determine the profile in a plane perpendicular to the profile itself.

24. Method according to claim 22, characterized in that the detection is carried out by means of recognition of an image taken facing the passage in order to determine the profile in a plane perpendicular to the profile itself.

25. Method according to claim 22, characterized in that the detection is carried out by means of a capacitive measurement (DMI).

26. Method according to claim 22, characterized in that the detection is carried out by means of distance sensors in order to detect the position of the feet in order to determine:
a) if a person's legs are far apart,
b) if a person has a trolley beside them,
c) if two people are passing through side by side.

27. Method according to claim 26, characterized in that in order to distinguish between cases b) and c) temperature sensors are used.

28. Method according to claim 21, characterized in that the detection is carried out by two crossed series of level 1 sensors.

29. Method according to claim 21, characterized in that the detection is carried out by a capacitive measurement system sensitive to the dielectric characteristics of the human body.

30. Method according to claim 14, characterized in that by means of the speed sensor (D3) a person turning back on themselves is detected.

31. Device for detecting a passage associated with an access door, for example a boarding gate or for entry to a secure building in particular in order to guarantee the passage of one person only, characterized in that it comprises:
a first detection level formed by a vertical row of active infrared emitting cells (D1) arranged opposite a vertical row of receiving cells in order to determine the profile of a person who is entering, these cells being connected to a central processing unit (CPU) which manages the sampling and the frequency of emission of the signals and means for controlling the opening of the access door or keeping it in the closed state.

32. Device according to claim 31, characterized in that it comprises a second detection level formed by a passive infrared cell (D2), for detecting the presence of a cold body.

33. Device according to claim 30, characterized in that it comprises:
a speed sensor (D3), for determining the speed of passage of the person,
means for modifying the profile determined by the first detection level in order to obtain a profile independent of the speed of passage,
means for comparing the profile obtained with an architecture of profiles contained in a memory.

34. Device according to claim 33, characterized in that the means for determining the speed of passage include a Doppler radar (D3).

35. Device according to claim 33, characterized in that the second detection level precedes the third detection level which is constituted by the speed sensor (D3).

36. Device according to claim 31, characterized in that it comprises a detection level for detecting the simultaneous passage of two people, comprising ultrasonic sensors (D4) arranged transversely to the passage.

37. Device according to claim 31, characterized in that it comprises a central processing unit (CPU) communicating with the different detection levels and with a memory (M) comprising an architecture of profiles, this control unit (CU) being able to compare the profiles determined by the sensors (D1, D2, D3, D4) to the profiles contained in the memory, to control as a function of the results of this comparison the opening of the access door or keeping it in the closed state and optionally triggering an alarm.

38. Device according to claim 35, characterized in that the radar (D3) of the third detection level is arranged at a certain distance from the entry (1) to the access door and is orientated so as to send its beam towards this entry (1).

39. Device according to claim 32, characterized in that the passive infrared cells (D2) of the second detection level comprise at least two cells arranged one above the other at the entry (1) to the door and orientated so as to send their beam transversely to the passage.

40. Device according to claim 36, characterized in that the sensors for the detection level of the simultaneous passage of several people comprise at least three ultrasonic sensors (D4) arranged at the upper part of the entry (1) to the access door and orientated so as to diffuse their beam downwards.

41. Device according to claim 31, in which the access door is bidirectional, characterized in that the entry (1) to and the exit (2) from the door each comprise a group of sensors (D1, D2, D3, D4) having identical functions.
